(19) United States
(12) Patent Application Publication
(10) Pub. No.: US 2017/0226373 A1
(43) Pub. Date: Aug. 10, 2017

(54) HIGH FLEX SUPER-WEATHERING TGIC COATING

(71) Applicant: Valspar Sourcing, Inc., Minneapolis, MN (US)

(72) Inventors: Thomas E. Reno, Americus, GA (US); Ryan A. Westhoff, Overland Park, KS (US)

(73) Assignee: Valspar Sourcing, Inc., Minneapolis, MN (US)

(21) Appl. No.: 15/496,556

(22) Filed: Apr. 25, 2017

Related U.S. Application Data
(63) Continuation of application No. PCT/US2015/057175, filed on Oct. 23, 2015.
(60) Provisional application No. 62/068,827, filed on Oct. 27, 2014.

(51) Int. Cl. C09D 167/02; C09D 167/08; C09D 167/07; C09D 5/03; C09D 7/12

(52) U.S. Cl. CPC C09D 167/02; C09D 5/036; C09D 5/035; C09D 7/125; C09D 167/07; C09D 167/08; C08K 3/22

(57) ABSTRACT

Methods and systems for coating metal substrates are provided. The methods and systems include application of TGIC-based powder coatings that demonstrate superdurability without compromising flexibility.

### CROSS-REFERENCE TO RELATED APPLICATION(S)

This application is a continuation of International Application No. PCT/US2015/057175 filed Oct. 23, 2015, which claims priority from U.S. Provisional Application Ser. No. 62/068,827, filed Oct. 27, 2014, each of which are incorporated herein by reference in its entirety.

### BACKGROUND

Powder coatings are solvent-free, 100% solid coating systems that have been used as low VOC and low cost alternatives to traditional liquid coatings and paints.

Superdurable powder coatings are used for architectural applications where increased weathering and resistance to atmospheric exposure are needed. These coatings are typically formed with a durable polyester resin applied as a topcoat over a conventional coating such as an electrocoat, for example. Such coatings typically demonstrate superior gloss retention and good chemical resistance. However, it is difficult to apply superdurable powder coatings over unprimed or uncoated surfaces, and the addition of pigments to these systems leads to poor weathering and reduced flexibility, with consequent failure between the powder coating and the electrocoat.

From the foregoing, it will be appreciated that there is a need for superdurable polyester resin-based powder coatings that provide excellent weathering characteristics without compromising coating flexibility.

### SUMMARY

The invention described herein includes systems for forming superdurable or superweathering and flexible coatings using at least one powder composition, where the powder composition includes a polyester resin composition and a pigment. In addition, the composition also includes at least one impact modifier, at least one hardener, and at least one stabilizing additive.

In another embodiment, the present invention includes methods and systems for coating a metal substrate. The method includes providing a substrate and at least one powder composition, where the powder composition includes a polyester resin composition and a pigment. In addition, the composition also includes at least one impact modifier, at least one hardener, and at least one stabilizing additive. In an aspect, the substrate may be a primed surface, an unprimed surface, or an electrocoated surface.

The details of one or more embodiments and aspects of the invention are set forth below. Other features, objects, and advantages of the invention will be apparent from the description and from the claims.

### SELECTED DEFINITIONS

Unless otherwise specified, the following terms as used herein have the meanings provided below.

The term “on”, when used in the context of a coating applied on a surface or substrate, includes both coatings applied directly or indirectly to the surface or substrate. Thus, for example, a coating applied to a primer layer overlying a substrate constitutes a coating applied on the substrate. Additionally, the term “substrate,” as used herein, refers to surfaces that are untreated, unprimed or clean-blasted, and also to surfaces that have been primed or pretreated by various methods known to those of skill in the art, such as electrocoating treatments, for example.

Unless otherwise indicated, the term “polymer” includes both homopolymers and copolymers (i.e., polymers of two or more different monomers). As used herein, the term “(meth)acrylate” includes both acrylic and methacrylic monomers and homopolymers as well as copolymers containing the same.

The term “smoothness”, as used herein, refers to the specular gloss or light reflectance from a powder-coated surface. It is typically obtained by comparing the specular reflectance from a coated sample to the specular reflectance from a black glass standard. As used herein, smoothness is expressed as 20-degree gloss measured using ASTM Method D523.

The term “weathering” as used herein, refers to the change in appearance and/or texture of a coating after prolonged exposure to a particular environment, such as outdoor weather, thermal radiation, uv radiation, and the like. Weathering is evaluated by ASTM Method G155, measuring the smoothness or gloss of the coating before and after exposure and expressing the result as percent gloss retention. A “superweathering” coating is defined herein as a coating that can retain about 40% gloss following exposure. The terms “superweathering” and “superdurable” are used interchangeably herein.

The term “flexible” as used herein, refers to the mechanical properties of the coating, including elongation compliance (as measured by the mandrel bend test, ASTM D522, for example), adhesion, resistance to blunt force impact (as determined by ASTM D2794, for example), and the like.

The term “comprises” and variations thereof do not have a limiting meaning where these terms appear in the description and claims.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a coating composition that comprises “an” additive can be interpreted to mean that the coating composition includes “one or more” additives.

Also herein, the recitations of numerical ranges by endpoints include all numbers subsumed within that range (e.g., 1 to 5 includes 1, 1.5, 2, 2.75, 3, 3.80, 4, 5, etc.). Furthermore, disclosure of a range includes disclosure of all subranges included within the broader range (e.g., 1 to 5 discloses 1 to 4, 1.5 to 4.5, 1 to 2, etc.).

### DETAILED DESCRIPTION

Embodiments of the invention described herein include methods and systems for powder-coating a metal substrate. The methods include steps for applying at least a first powder composition to a substrate, wherein the composition includes a polyester resin, a pigment, a hardener, an impact modifier, and a stabilizing additive. The methods further include curing the composition to obtain a cured coating with good flexibility and superdurability.

Accordingly, in some embodiments, the present invention provides methods or systems for coating a substrate. In an aspect, the method and systems described herein include applying a powder composition to a substrate already coated with a primer layer. In another aspect, the method and systems described herein include applying a powder composition to a substrate already coated with one or more electrocoat layers. In yet another aspect, the methods and system described herein include applying a powder composition to an unprimed substrate, i.e. cold-rolled steel, for example.

In an embodiment, the methods described herein include applying at least a first powder composition to a substrate. The powder composition is a fusible composition that melts on application of heat to form a coating film. The powder is applied using methods known to those of skill in the art, such as, for example, electrostatic spray methods, to a film thickness of about 10 to about 50 microns, preferably 20 to 40 microns. In an aspect, the first powder composition is applied to either the clean (i.e. unprimed) or pretreated surface of a metal substrate, i.e. the first powder composition may be applied to a metal surface that is unprimed, that has been clean-blasted, or a surface that has been pretreated by various methods known to those of skill in the art, such as electrocoat, for example.

In an embodiment, the first powder composition includes at least one polymeric binder. The powder composition may also optionally include one or more pigments, opacifying agents or other additives.

Suitable polymeric binders generally include a film forming resin and optionally a curing agent for the resin. The binder may be selected from any resin or combination of resins that provides the desired film properties. Suitable examples of polymeric binders include amorphous and crystalline thermoset and/or thermoplastic materials, and can be made with epoxy, polyester, polyurethane, polyamide, acrylic, polyvinylchloride, nylon, fluoropolymer, silicone, other resins, or combinations thereof. Thermoset materials are preferred for use as polymeric binders in powder coating applications, and epoxies, polyesters and acrylics are particularly preferred. If desired, elastomeric resins may be used for certain applications. In an aspect, specific polymeric binders or resins are included in the powder compositions described herein depending on the desired end use of the powder-coated substrate. For example, certain high molecular weight polyesters show superior corrosion resistance and are suitable for use on substrates used for interior and exterior applications. Similarly, amorphous polyesters are useful in applications where clarity, color, and chemical resistance are desired.

Examples of preferred binders include the following: carboxyl-functional polyester resins cured with epoxide-functional compounds (e.g., triglycidyl-isocyanurate or TGIC), carboxyl-functional polyester resins cured with polymeric epoxy resins, carboxyl-functional polyester resins cured with hydroxyalkyl amides, hydroxyl-functional polyester resins cured with blocked isocyanates or uretdiones, epoxy resins cured with amines (e.g., dicyandiamide), epoxy resins cured with phenolic-functional resins, epoxy resins cured with carboxyl-functional curatives, carboxyl-functional acrylic resins cured with polymeric epoxy resins, hydroxyl-functional acrylic resins cured with blocked isocyanates or uretdiones, unsaturated resins cured through free radical reactions, and silicone resins used either as the sole binder or in combination with organic resins. The optional curing reaction may be induced thermally, or by exposure to radiation (e.g., UV, UV-vis, visible light, IR, near-IR, and e-beam).

In a preferred embodiment, the polymeric binder of the powder composition is an isopthalic-based TGIC-reactive polyester resin composition. TGIC, a triazine compound with reactive epoxy functional groups, is known in the art as a curing agent for acid-functional resins, such as acrylic resins, polyester resins, and the like, for example. These TGIC-reactive resins are known to have high hardness, good chemical resistance and good weathering, but suffer from poor flexibility and impact resistance.

In an embodiment, the polymeric binder of the powder composition includes a coil resin. Typical coil resins include polyesters, acrylates, alkyds, and the like. In a preferred aspect, the coil resins used in the powder compositions described herein include linear polyesters, acrylate-modified polyesters, or alkyd-modified polyesters. In a preferred aspect, up to about 20 wt %, preferably 30 wt %, more preferably 40 wt % of the isophthalic-based TGIC-reactive polyester is replaced with the coil resin.

Without limiting to theory, it is believed that the weatherability and impact resistance of coatings made from TGIC-reactive polyesters may be improved by using fillers or pigments. Accordingly, in an embodiment, the powder composition described herein includes at least one filler, dye or pigment. Various organic or inorganic pigments may be used in the present invention. Suitable pigments include, without limitation, titanium dioxide (TiO₂), carbon black, red iron oxide, yellow iron oxide, raw umber, phthalocyanine blue, phthalocyanine green, naphthol red, toluidine red, various organic yellows, carbazole violet, and quinacridones. If desired, processed coloring pigments, such as pigments that have been coated with polymeric materials may be used. Suitable such pigments include SURPASS products from Sun Chemical. In a preferred embodiment, the powder composition described herein includes TiO₂ as a pigment. Without limiting to theory, it is believed that the weatherability of a powder coating may be improved by using additives that enhance the impact resistance of the coating composition. Accordingly, in an embodiment, the first powder composition includes at least one impact modifier. Conventionally, impact modifiers are graft copolymers of crosslinked alkyl (meth)acrylate rubbers with other alkyl (meth)acrylates, styrene, acrylonitrile, and the like, and have two or more layers. In an aspect, the layers of the impact modifier have a core-shell structure, with the core preferably including, without limitation, homopolymers or copolymers of butadiene, sytrene, (meth)acrylic monomers, co-polymers of butadiene and (meth)acrylic monomers, copolymers of butadiene, (meth)acrylic monomers, vinyl ester monomers, vinyl halide monomers, and the like, or combinations thereof. The shell preferably includes, without limitation, polymers or graft copolymers of alkyl (meth)acrylate rubbers and the like. In a preferred aspect, the impact modifier has a butadiene or (meth)acrylate core, with a polymethyl methacrylate (PMMA) shell. In an embodiment, the powder composition described herein includes about up to 10 wt % impact modifier, preferably about 1 wt % to 5 wt %, more preferably about 2 wt % to 4 wt %, based on the total weight of the powder composition.

In an embodiment, the powder composition described herein includes other additives, such as hardeners or curing agents, for example. Typically, hardeners are additives used in powder compositions to accelerate cure rates. Without limiting to theory, hardeners act as coreactants with the polymeric binder resin, resulting in crosslinking and subsequent curing. Hardeners for use in the methods and systems described herein include, without limitation, monofunctional, difunctional and polyfunctional compounds, such as, for example, amines, acids, acid anhydrides, phenols, alcohols, thiols, and derivatives and combinations thereof. In a preferred aspect, the hardener is an isocyanate hardener or polyisocyanate hardener, including, for example, the Desmodur® line of polyisocyanate compounds (Bayer Material Sciences, Germany). In a preferred aspect, the powder composition described herein includes up to about 12 wt % polyisocyanate hardener, preferably about 1 to 8 wt %, more preferably about 2 to 6 wt %, based on the total weight of the powder composition.

The powder composition may include other additives. These other additives can improve the application of the powder coating, the melting and/or curing of that coating, or the performance or appearance of the final coating. Examples of optional additives which may be useful in the powder include: cure catalysts, antioxidants, color stabilizers, slip and mar additives, UV absorbers, hindered amine light stabilizers, photoinitiators, conductivity additives, tribocharging additives, anti-corrosion additives, fillers, texture agents, degassing additives, flow control agents, thixotropes, and edge coverage additives. In a preferred aspect, the powder composition includes hindered amine light stabilizers (HALS) in combination with equal parts of a UV absorber. Examples of HALS include, without limitation, 2,2,6,6-tetramethyl piperidine and its derivatives, N—R type hindered amines, N—OR type hindered amines, and the like. Examples of UV absorbers include, without limitation, benzotriazoles, triazines, benzophenones, cyanoacrylates, and the like. The combination of HALS and UV absorbers is present in an amount of preferably up to about 10 wt %, more preferably 1 to 5 wt %, based on the total weight of the powder composition.

The powder coating composition described herein is made by conventional methods known in the art. The polymeric binder is dry mixed together with the additives, and then is typically melt blended by passing through an extruder. The resulting extrudate is solidified by cooling, and then ground or pulverized to form a powder. Other methods may also be used. For example, one alternative method uses a binder that is soluble in liquid carbon dioxide. In that method, the dry ingredients are mixed into the liquid carbon dioxide and then sprayed to form the powder particles. If desired, powders may be classified or sieved to achieve a desired particle size and/or distribution of particle sizes.

The resulting powder is at a size that can effectively be used by the application process. Practically, particles less than 10 microns in size are difficult to apply effectively using conventional electrostatic spraying methods. Consequently, powders having median particle size less than about 25 microns are difficult to electrostatically spray because those powders typically have a large fraction of small particles. Preferably the grinding is adjusted (or sieving or classifying is performed) to achieve a powder median particle size of about 25 to 150 microns, more preferably 30 to 70 microns, most preferably 30 to 50 microns.

Optionally, other additives may be used in the present invention. As discussed above, these optional additives may be added prior to extrusion and be part of the base powder, or may be added after extrusion. Suitable additives for addition after extrusion include materials that would not perform well if they were added prior to extrusion; materials that would cause additional wear on the extrusion equipment, or other additives.

Additionally, optional additives include materials which are feasible to add during the extrusion process, but may also be added later. The additives may be added alone or in combination with other additives to provide a desired effect on the powder finish or the powder composition. These other additives can improve the application of the powder, the melting and/or curing, or the final performance or appearance. Examples of optional additives which may be useful include: cure catalysts, antioxidants, color stabilizers, slip and mar additives, photoinitiators, conductivity additives, tribocharging additives, anti-corrosion additives, fillers, texture agents, degassing additives, flow control agents, thixotropes, and edge coverage additives.

Other preferred additives include performance additives such as rubberizers, friction reducers, and microcapsules. Additionally, the additive could be an abrasive, a heat sensitive catalyst, an agent that helps create a porous final coating, or that improves wetting of the powder.

Techniques for preparing powder compositions are known to those of skill in the art. Mixing can be carried out by any available mechanical mixer or by manual mixing. Some examples of possible mixers include Henschel mixers (available, for example, from Henschel Mixing Technology, Green Bay, WI), Mixaco mixers (available from, for example, Triad Sales, Greer, SC or Dr. Herfeld GmbH, Neuenrade, Germany), Marion mixers (available from, for example, Marion Mixers, Inc., 3575 3rd Avenue, Marion, Iowa), invertible mixers, Littleford mixers (from Littleford Day, Inc.), horizontal shaft mixers and ball mills. Preferred mixers would include those that are most easily cleaned.

Powder coatings are generally manufactured in a multi-step process. Various ingredients, which may include resins, curing agents, pigments, additives, and fillers, are dry-blended to form a premix. This premix is then fed into an extruder, which uses a combination of heat, pressure, and shear to melt fusible ingredients and to thoroughly mix all the ingredients. The extrudate is cooled to a friable solid, and then ground into a powder. Depending on the desired coating end use, the grinding conditions are typically adjusted to achieve a powder median particle size of about 25 to 150 microns.

The final powder may then be applied to an article by various means including the use of fluid beds and spray applicators. Most commonly, an electrostatic spraying process is used, wherein the particles are electrostatically charged and sprayed onto an article that has been grounded so that the powder particles are attracted to and cling to the article. After coating, the article is heated. This heating step causes the powder particles to melt and flow together to coat the article. Optionally, continued or additional heating may be used to cure the coating. Other alternatives such as UV curing of the coating may be used.

The coating is optionally cured, and such curing may occur via continued heating, subsequent heating, or residual heat in the substrate. In another embodiment of the invention, if a radiation curable powder coating base is selected, the powder can be melted by a relatively short or low temperature heating cycle, and then may be exposed to radiation to initiate the curing process. One example of this embodiment is a UV-curable powder. Other examples of radiation curing include using UV-vis, visible light, near-IR, IR and e-beam.

The compositions and methods described herein may be used with a wide variety of substrates. Typically and preferably, the powder coating compositions described herein are used to coat metal substrates, including without limitation, unprimed metal, clean-blasted metal, and pretreated metal, including plated substrates, ecoat-treated metal substrates, and substrates that are the same color as the powder coating composition. Typical pretreatments for metal substrates include, for example, treatment with iron phosphate, zinc phosphate, and the like. Metal substrates can be cleaned and pretreated using a variety of standard processes known in the industry. Examples include, without limitation, iron phosphating, zinc phosphating, nanoceramic treatments, various ambient temperature pretreatments, zirconium containing pretreatments, acid pickling, or any other method known in the art to yield a clean, contaminant-free surface on a substrate.

The coating compositions and methods described herein are not limited to conversion coatings, i.e. parts or surfaces treated with conversion coatings. Moreover, the coating compositions described herein may be applied to substrates previously coated by various processes known to persons of skill in the art, including for example, ecoat methods, plating methods, and the like. There is no expectation that substrates to be coated with the compositions described herein will always be bare or unprimed metal substrates.

Preferably, the coated substrate has desirable physical and mechanical properties. Typically, the final film coating will have a thickness of 25 to 200 microns, preferably 50 to 150 microns, more preferably 75 to 125 microns.

Conventionally, when developing TGIC-based powder coating, the weatherability of the coating can be improved by using isophthalic-based polyester resins, as this is believed to improve the coating's resistance to UV degradation. However, the use of isophthalic-based TGIC-reactive resins reduces the flexibility of the coating. Moreover, this flexibility is further reduced when TiO₂ and/or other pigments are used in the composition. Surprisingly, the methods and systems described herein combine isophthalic-based TGIC-reactive resins with TiO₂ and other additives to produce a superdurable coating without compromising flexibility.

The flexibility of the coatings produced by the methods and systems described herein is evaluated by determining coating elongation compliance using the Mandrel Bend Test (ASTM D522) at various different film builds. The flexibility of the coating is also assessed by testing blunt force impact resistance using a weighted impact tester in direct and indirect contact modes (ASTM D2794). The powder composition described herein produces coating that have optimal flexibility over various substrates. For example, when applied over an electrocoated surface, significantly less adhesive failure between the powder coating and electrocoat layers is seen. Without limiting to theory, it is believed that the powder coating absorbs stress from the electrocoat and thereby prevents failure between the powder and electrocoat layers.

The weathering or durability of the coatings produced by the methods and systems described herein is measured using a Xenon arc accelerated weathering test chamber and evaluating the coating's percentage of gloss retention after a 2000 hour cycle. Specifically, the 20° gloss of the coating is measured before and after completion of the cycle, according to ASTM G155, cycle 7. A superweathering or superdurable coating will demonstrate a result of preferably at least 20+% gloss retention, more preferably 30+%, and most preferably 40+% after completion.

What is claimed is:

1. A powder coating system for forming a flexible and superweathering coating, comprising:
at least a first powder coating composition, comprising
a polyester resin composition;
at least one pigment;
about 1 to 10 wt % of at least one impact modifier, based on the weight of the total composition;
about 1 to 12 wt % of at least one hardener, based on the weight of the total composition; and
about 1 to 10 wt % of at least one stabilizing additive, based on the weight of the total composition.

2. The system of claim 1, wherein the polyester resin composition is an isophthalic based polyester resin.

3. The system of claim 1, wherein the polyester resin composition is an isophthalic-based TGIC-reactive polyester resin.

4. The system of claim 1, wherein the polyester resin composition comprises up to about 40 wt % of a linear polyester resin.

5. The system of claim 1, wherein the linear polyester resin is acrylate-modified.

6. The system of claim 1, wherein the linear polyester resin is alkyd-modified.

7. The system of claim 1, wherein the impact modifier is a core-shell composition.

8. The system of claim 1, wherein the core component of the impact modifier is selected from the group consisting of polymers of butadiene, co-polymers of butadiene and sytrene, (meth)acrylic monomers, co-polymers of butadiene and (meth)acrylic monomers, copolymers of butadiene, (meth)acrylic monomers, and combinations thereof.

9. The system of claim 1, wherein the shell component of the impact modifier is a grafted polymethylmethacrylate (PMMA) polymer.

10. The system of claim 1, wherein the pigment is TiO₂.

11. The system of claim 1, wherein the superweatherable coating has 20° degree gloss retention of at least about 40%.

12. The system of claim 1, wherein the hardener is an isocyanate hardener.

13. The system of claim 1, wherein the stabilizing additive is a hindered amine light stabilizer.

14. The system of claim 1, wherein the stabilizing additive is a UV absorber.

15. The system of claim 1, wherein the stabilizing additive is a combination of one or more HALS and one or more UV absorbers.

16. The system of claim 1, wherein the substrate is an electrocoated surface.

17. The system of claim 1, wherein the substrate is an unprimed surface.

18. The system of claim 1, wherein the substrate is a primed surface.

19. The system of claim 1, wherein the substrate is cold rolled steel.
